(19) United States
(12) Patent Application Publication
(10) Pub. No.: US 2006/0220629 A1
(43) Pub. Date: Oct. 5, 2006

(54) DC-DC converter

(76) Inventors: Hiroshi Saito, Tokyo (JP); Ryou Watabe, Kanagawa (JP); Takuya Ishii, Osaka (JP)

Correspondence Address: MCDERMOTT WILL & EMERY LLP, 600 13TH STREET, N.W., WASHINGTON, DC, 20005-3096, US

(21) Appl. No.: 11/396,647

(22) Filed: Apr. 4, 2006

(30) Foreign Application Priority Data
Apr. 4, 2005 (JP) 2005-107826

(51) Int. Cl. G05F 1/00

(52) U.S. Cl. 323/282

(57) ABSTRACT

A DC-DC converter includes a switch, a rectifier, a smoothing circuit, and a control circuit. The control circuit includes an output detection circuit for outputting an error signal, a current detection circuit for outputting a current detection signal in a period in which at least the switch is OFF, a first circuit for outputting a first signal for setting a timing of turning ON of the switch according to a comparison result between the error signal and the current detection signal, and a second circuit for outputting a second signal for setting an ON time of the switch, according to a reduction in output power from the smoothing circuit, so that the ON time of the switch is reduced, and generates the control signal, based on the first and second signals.

### CROSS REFERENCE TO RELATED APPLICATIONS

The disclosure of Japanese Patent Application No. 2005-107826 filed on Apr. 4, 2005 including specification, drawings and claims are incorporated herein by reference in its entirety.

### BACKGROUND OF THE INVENTION

The present invention relates to a DC-DC converter for supplying a controlled DC (direct current) voltage to various kinds of electronic equipment, and more particularly relates to a control system for adjusting an OFF time of a switch which is a major component of a DC-DC converter.

In recent years, a DC-DC converter is used for a CPU power supply for personal computer and the like in many cases. For example, a step-down DC-DC converter for controlling a lower DC voltage than a power supply voltage and supplying the controlled DC voltage to a load includes an inductor, a high side switch and a low side switch. The high side switch and the low side switch are connected in series between a power supply voltage and a ground voltage. In the step-down DC-DC converter, the high side switch and the low side switch are alternately turned ON/OFF and this tuning ON/OFF operation of the high side switch and the low side switch is repeated. In accordance with this operation, the inductor repeatedly performs storage and release of magnetic energy. An AC (alternate current) voltage generated when the inductor stores and releases magnetic energy is rectified and then supplied as an output voltage to a load. The output voltage is adjusted according to the ratio of ON time of the high side switch to a cycle thereof. An inductor current is a triangular wave current which repeatedly increases/reduces according to turning ON/OFF of the switches. Normally, a current mode control DC-DC converter controls peak and valley values of an inductor current, thereby controlling an ON time or an OFF time of the high side switch.

In a peak control system for controlling an ON time of the high side switch, it is necessary to detect a current flowing in a high side switch and thus a circuit for detecting a current flowing in the high side switch and peripheral circuits thereof are provided in a power supply voltage side. Therefore, to precisely detect a current for a power supply voltage which is likely to fluctuate, a complicated circuit configuration is needed. In contrast, a valley control system for controlling an OFF time by detecting a current flowing in a low side switch has a configuration in which a circuit for detecting a current flowing in the low side switch and its peripheral circuits are provided in a ground side. That is, the valley control system has simple circuit configuration.

Furthermore, in recent years, the tendency has been toward reduction in output voltage. Accordingly, an ON time of the high side switch is also reduced. In a peak control system for controlling an ON time, a current flowing in the high side switch has to be detected and also an ON time of the high side switch has to be controlled in a short time when the high side switch is ON. However, if an OFF time of the high side switch is controlled, a current flowing in the low side switch may be detected and an OFF time of the high side switch may be controlled when the high side switch is OFF, so that a control time can be longer. For example, a known DC-DC converter employing a valley control system described in Japanese Laid-Open Publication No. 2001-136737 has been proposed.

Hereinafter, for example, the known DC-DC converter disclosed in Japanese Laid-Open Publication No. 2001-136737 will be described with reference to FIG. 7 as an exemplary valley control system for controlling an OFF time of a high side switch. In Japanese Laid-Open Publication No. 2001-136737, a method for detecting a current by using an ON resistance of a low side switch formed of a MOSFET is disclosed. However, in FIG. 7, a generalized form of a current detection section shown in FIG. 1 in Japanese Laid-Open Publication No. 2001-136737 is illustrated.

As shown in FIG. 7, the known DC-DC converter includes a high side switch 11, a low side switch 12, an inductor 13, an output capacitor 14, an error amplifier 21, a comparator 22, a current detector 23, an RS latch 24, and a timer circuit 25. An input terminal Vi receives an input voltage Vi and an output terminal Vo outputs an output voltage Vo.

The high side switch 11 in an input voltage Vi side and the low side switch 12 in a ground potential side are connected in series between the input voltage Vi and a ground potential. The inductor 3 and the output capacitor 4 are connected between a junction of the high side switch 11 and the low side switch 12 and the output terminal Vo so as to form an LC filter. The high side switch 11 and the low side switch 12 are complementarily turned ON/OFF. A switching voltage generated at the junction of the high side switch 11 and the low side switch 12 is rectified and smoothed and then output as the output voltage Vo.

An error amplifier 21 calculates an error between a reference voltage Vr as a non-inversion input and the output voltage Vo as an inversion input, amplifies a result of the calculation and outputs an amplified calculation result as an error signal Ve. The comparator 22 outputs a set signal ST to a set input of the RS latch 24, based on a result of subtraction between an error signal Ve as a non-inversion input and a current detection signal Vc1 as an inversion input.

When the low side switch 12 is ON, the current detector 23 detects a current flowing into the inductor 13 via the low side switch 12, voltage-converts a detected current to generate a current detection signal Vc1, and outputs the current detection signal Vc1. The timer circuit 25 is connected to a reset input of the RS latch 24 and outputs a reset signal CK after a lapse of a predetermined time from turning ON of the high side switch 11.

Hereinafter, the basic operation of the known DC-DC converter of FIG. 7 will be described.

When the high side switch 11 is ON, a voltage difference (Vi−Vo) between the input voltage Vi and the output voltage Vo is applied to the inductor 13. At this time, an inductor current IL flowing in the inductor 13 is linearly increased, and the inductor 13 stores magnetic energy.

On the other hand, when the high side switch 11 is OFF, the output voltage Vo is applied to the inductor 13 in the inverse direction. At this time, the inductor current IL flowing in the inductor 13 is linearly reduced, and the inductor 13 releases magnetic energy.

The inductor current IL flowing in the inductor 13 is smoothed by the output capacitor 14 and an averaged DC current is supplied to an output terminal. While the output voltage Vo is fed back to an inversion input of the error amplifier 21, the reference voltage Vr is input to a non-inversion input of the error amplifier 21. The error signal Ve which is an output from the error amplifier 21 is received by a non-inversion input of the comparator 22. The current detection signal Vc1 obtained by current-voltage converting a current flowing in the low side switch 12 is input to an inversion input of the comparator 22.

When the inductor current IL flowing in the inductor 13 is reduced and the current detection signal Vc1 is reduced to the level of the error signal Ve from the error amplifier 21, the comparator 22 inverts its output. That is, the comparator 22 changes the set signal ST for the RS latch 24 to an H level, so that the high side switch 11 is turned ON. Thus, charging of the inductor 13 is started.

After a predetermined time has lapsed since the set signal ST which is an output of the comparator 22 is changed to the H level and the high side switch 11 is turned ON, the timer circuit 25 outputs a reset signal CK to the RS latch 24, so that the high side switch 11 is turned OFF.

In the manner described above, the high side switch 11 and the low side switch 12 are repeatedly turned ON/OFF in a complementary manner and the output voltage Vo which is a DC voltage is supplied.

Next, the operation of stabilizing the output voltage Vo in the known DC-DC converter will be described.

First, the case where an output current Io from the output terminal is increased, so that the output voltage Vo is reduced to below a desired value will be considered. In this case, the error amplifier 21 which has detected a reduction in the output voltage Vo increases the error signal Ve to be output. When the error signal Ve is increased, a time which it takes for the current detection signal Vc1 of the low side switch 12 to reach the level of the error signal Ve is reduced. In other words, a time for which the high side switch 11 is OFF is reduced. A time for which the high side switch 11 is ON is set by the timer circuit 25 and is constant. Therefore, the inductor current IL is increased overall. Thus, a power supplied to the output capacitor 14 is increased and the output voltage Vo which has been reduced is increased.

In contrast, the case where the output current Io from the output terminal is reduced, so that the output voltage Vo is increased to exceed a desired value will be considered. In this case, the error amplifier 21 which has detected an increase in the output voltage Vo reduces the error signal Ve to be output. When the error signal Ve is reduced, a time which it takes for the current detection signal Vc1 of the low side switch 12 to reach the level of the error signal Ve is increased. In other words, a time for which the high side switch 11 is OFF is increased. A time for which the high side switch 11 is ON is set by the timer circuit 25 and is constant. Therefore, the inductor current IL is reduced overall. Thus, a power supplied to the output capacitor 14 is reduced and the output voltage Vo which has been increased is reduced.

By the above-described operation, the known DC-DC converter stably maintains the output voltage Vo of a predetermined value.

FIG. 8 is an operation waveform chart for the inductor current IL and the output voltage Vo under heavy load conditions in the known DC-DC converter.

When the high side switch 11 and the low side switch 12 are repeatedly turned ON/OFF in an alternating manner, the inductor current IL has an operation waveform having a triangular wave shape in which the inductor current IL is linearly increased/reduced as shown in the operation waveform chart of FIG. 8. An average value of the inductor current IL becomes the output current Io and a current (IL−Io) obtained by subtracting the output current Io from the inductor current IL becomes a ripple current to flow in the output capacitor 14. Voltage fluctuation of the output capacitor 14 associated with the ripple current (IL−Io) is superimposed as the output ripple voltage Vrpl on the output voltage Vo. If it is assumed that a switching cycle is T, a variation range of the inductor current IL is ΔIL and a capacitance of the output capacitor 14 is C, an amplitude ΔVrpl of the output ripple voltage is expressed by Equation 1.
ΔVrpl=ΔIL×T/(4C) [Equation 1]

However, in the known DC-DC converter employing the above-described valley control system, when a load to which an output voltage is supplied is a light load, a valley value of an inductor current might be 0. In such a case, an ON time Ton of a high side switch is constant, and an output voltage is increased to exceed a desired value. Therefore, it is necessary to perform, after turning OFF of a low side switch, an intermittent operation in which the high side switch is not turned ON for a predetermined time. Specifically, assume that a load to which an output voltage is supplied is a light load and a valley value of an inductor current is 0. When an output voltage exceeds a desired value, an OFF state of the high side switch is maintained to detect a drop of the output voltage to a desired value and then the high side switch is turned ON. This intermittent operation has also a problem. That is, as the load is lighter, an output voltage associated with charging of the output capacitor is increased more largely. Accordingly, as the load is lighter, an output ripple voltage to be superimposed on an output voltage is increased. Furthermore, as clearly shown by comparison between FIG. 8 and FIG. 9, which will be shown later, an output ripple voltage shown in FIG. 9 is increased more largely than an output ripple voltage shown in FIG. 8, and an error between an output voltage and a desired value is generated (this error corresponds to ½ of the output ripple voltage). This will be specifically described in the following with reference to FIG. 9.

FIG. 9 is an operation waveform chart for the inductor current IL and the output voltage Vo under light load conditions.

The ON time Ton of the high side switch is the same as that under heavy load conditions and, accordingly, the variation range ΔIL of the inductor current IL is the same. However, the output current Io is small and there is a period Tx in which the inductor current IL is 0, and thus charge stored in an output capacitor in a single switching cycle is larger than that under heavy load conditions as shown in FIG. 8 and the output ripple voltage is increased. The amplitude ΔVrpl of the output ripple voltage is expressed by Equation 2.
ΔVrpl=(ΔIL−Io)²×(T−Tx)/(2C×ΔIL) [Equation 2]

In this case, if (T−Tx) in Equation 2 is equal to the switching cycle T under heavy load conditions shown in FIG. 8 and Io=0 holds, the amplitude ΔVrpl of the output ripple voltage is expressed by Equation 3.
ΔVrpl=ΔIL×T/(2C) [Equation 3]
The amplitude ΔVrpl of the output ripple voltage under light load conditions is twice as large as the amplitude ΔVrpl of the output ripple voltage under heavy load conditions.

As has been described, when an intermittent operation is performed, as a load is lighter, an output voltage associated with charging the output capacitor is increased more largely.

### SUMMARY OF THE INVENTION

In view of the above-described problems, it is an object of the present invention to provide a DC-DC converter which is a current mode control DC-DC converter for controlling a valley value of an inductor current, i.e., an OFF time of a switch, to control an output voltage, and in which an output voltage can be controlled with high accuracy even under light load conditions where a valley value of the inductor current reaches 0.

To achieve the above-described object, a DC-DC converter according to an aspect of the present invention is characterized in that the DC-DC converter includes: a switch for receiving an input voltage and applying the input voltage or part of the input voltage to an inductor by an ON/OFF operation; a rectifier for rectifying the voltage generated in the inductor; a smoothing circuit for smoothing the rectified voltage to generate an output voltage; and a control circuit for generating a control signal for controlling the ON/OFF operation and outputting the control signal to the switch, and the control circuit includes an output detection circuit for outputting an error signal corresponding to a difference between the output voltage and a reference voltage, a current detection circuit for detecting a current flowing in the inductor in a period in which at least the switch is OFF and outputting a result of the detection as a current direction signal, a first circuit for generating a first signal for setting a timing of turning ON of the switch according to a result of comparison between the error signal and the current detection signal and outputting the first signal, and a second circuit for generating a second signal for setting an ON time of the switch, according to reduction in output power from the smoothing circuit, so that the ON time of the switch is reduced, and generates the control signal, based on the first signal and the second signal.

In an embodiment of the present invention, it is preferable that in the DC-DC converter, the second circuit generates the second signal according to a level of the current detection signal.

In another embodiment of the present invention, it is preferable that in the DC-DC converter, the second circuit generates the second signal, according to a level of the current detection signal, so that the ON time of the switch is reduced in a stepwise manner.

In still another embodiment of the present invention, the DC-DC converter may have a configuration in which the second circuit includes a comparator for comparing the current detection signal with a predetermined value, a latch circuit for maintaining an output of the comparator after a lapse of a predetermined time from turning OFF of the switch and outputting the output, and a timer circuit for receiving an output of the latch circuit and generating the second signal.

In this case, the second circuit may have a configuration including a plurality of pairs of the comparator and the latch circuit, and in receiving a plurality of outputs of the plurality of latch circuits, the timer circuit generates the second signal according to a combination of the plurality of outputs.

Moreover, it is preferable that the timer circuit has a configuration including a plurality of constant current sources, a capacitor and a comparator, and in receiving the outputs of the latch circuits, the timer circuit switches the plurality of constant current sources from one to another to charge the capacitor and sets the ON time of the switch according to a charging time for the capacitor.

Furthermore, the timer circuit may have a configuration including a constant current source, a plurality of capacitors and a comparator, and in receiving the outputs of the latch circuits, the timer circuit switches the plurality of capacitors from one to another to charge the plurality of capacitors and sets the ON time of the switch according to a charging time for the plurality of capacitors.

In one embodiment of the present invention, it is preferable that in the DC-DC converter, the second circuit generates the second signal according to a level of a signal which has detected the output current from the smoothing circuit.

In this case, it is preferable that when the level of the signal which has detected the output current from the smoothing signal is smaller than a predetermined value, the second circuit generates the second signal so that the larger a difference between the level of the signal and the predetermined value is, the smaller the ON time of the switch becomes.

Moreover, it is preferable that the second circuit has a configuration including an output current detection circuit for detecting the output current from the smoothing circuit and generating an output current detection signal, and a timer circuit for generating the second signal according to the level of the output current detection signal.

As has been described, in a DC-DC converter according to the present invention, an ON time of a switch can be set to be shorter as a load is lighter. Thus, a continuous operation of an inductor current can be performed with a wider load range. Even if an intermittent operation is started, an output ripple voltage can be reduced. Therefore, an output voltage can be controlled with high accuracy.

According to the present invention, a valley value of an inductor current is controlled for output control. Specifically, in a current mode control DC-DC converter for controlling an OFF time of a high side switch, with a lighter load, an ON time of the high side switch is reduced. Thus, compared to a known configuration, a lighter load condition can be set as a load condition for the DC-DC converter where an inductor current reaches 0 and, moreover, an output ripple voltage in an intermittent operation can be reduced. That is, a continuous operation of an inductor current can be performed in a wider load range than that in a known technique. Therefore, an output voltage can be controlled with high accuracy and, even if an intermittent operation is started, an output ripple voltage can be reduced, so that an output voltage can be controlled with high accuracy.

### BRIEF DESCRIPTION OF THE DRAWINGS

FIG. 1 is a block diagram illustrating an exemplary circuit configuration of a DC-DC converter according to a first embodiment of the present invention.

FIGS. 2A through 2C are operation waveform charts for a DC-DC converter according to the first embodiment of the present invention: FIG. 2A is an operation waveform chart under heavy load conditions and in a continuous operation; FIG. 2B is an operation waveform chart under light load conditions and in a continuous operation; and FIG. 2C is an operation waveform chart under light load and in a discontinuous operation.

FIG. 3 is an operation waveform chart for a second circuit in a DC-DC converter according to the first embodiment of the present invention.

FIG. 4A is a circuit diagram illustrating an exemplary configuration of a timer circuit 96 in a DC-DC converter according to the first embodiment of the present invention; and FIG. 4B is an operation waveform chart for the timer circuit 96 according to the first embodiment of the present invention.

FIG. 5 is a circuit diagram illustrating a modified example of the circuit configuration of the timer circuit 96 in the DC-DC converter according to the first embodiment of the present invention.

FIG. 6 is a circuit diagram illustrating an exemplary configuration of a DC-DC converter according to a second embodiment of the present invention.

FIG. 7 is an operation waveform chart for a known DC-DC converter under heavy load conditions and in a continuous operation.

FIG. 8 is an operation waveform chart for a known DC-DC converter under light load conditions and in a discontinuous operation.

FIG. 9 is an operation waveform chart for inductor current and output voltage under light load conditions.

### DESCRIPTION OF THE PREFERRED EMBODIMENTS

Hereinafter, preferred embodiments of the present invention will be described with reference to the accompanying drawings.

### First Embodiment

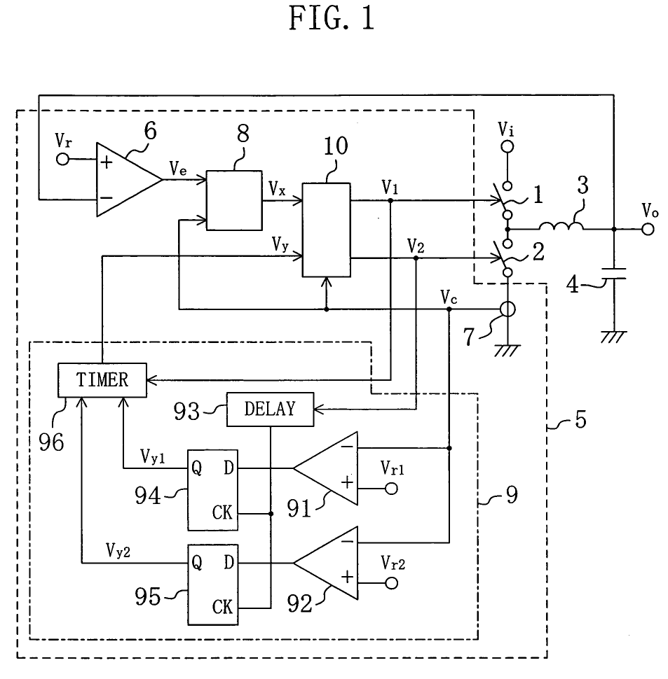

Hereinafter, a DC-DC converter according to a first embodiment of the present invention will be described with reference to FIGS. 1 through 5.

First, a circuit configuration of the DC-DC converter of the first embodiment of the present invention will be described.

FIG. 1 is a block diagram illustrating an exemplary circuit configuration of the DC-DC converter of the first embodiment of the present invention.

As shown in FIG. 1, the DC-DC converter of the first embodiment of the present invention includes a high side switch 1, a low side switch (rectifier) 2, an inductor 3, an output capacitor (smoothing circuit) 4 and a control circuit 5. An input terminal receives an input voltage Vi and an output terminal outputs an output voltage Vo.

The control circuit 5 includes an output detection circuit 6, a current detection circuit 7, a first circuit 8, a second circuit 9 and a driving circuit 10.

The second circuit 9 includes a first comparator 91, a second comparator 92, a delay circuit 93, a first D latch 94, a second D latch 95 and a timer circuit 96.

The high side switch 1 in an input voltage Vi side and a low side switch 2 in a ground potential side are connected in series between the input voltage Vi and a ground voltage. The inductor 3 and the output capacitor 4 are connected between a junction of the high side switch 1 and the low side switch 2 and the output terminal so as to form an LC filter. The high side switch 1 and the low side switch 2 are complementarily turned ON/OFF based on a first driving signal V1 and a second driving signal V2, respectively, which are output from the control circuit 5. A switching voltage generated at the junction of the high side switch 1 and the low side switch 2 is rectified and smoothed, and then is output as an output voltage Vo.

The output detection circuit 6 in the control circuit 5 is formed of an operational amplifier. The output detection circuit 6 calculates an error between a reference voltage Vr as a non-inversion input and an output voltage Vo as an inversion input, amplifies a result of the calculation and outputs an amplified result as an error signal Ve. In this case, the error signal Ve is reduced when the output voltage Vo becomes larger than the reference voltage Vr and is increased when the output voltage Vo becomes lower than the reference voltage Vr.

When the low side switch 2 is ON, the current detection circuit 7 in the control circuit 5 detects a current flowing to the inductor 3 via the low side switch 2, current-voltage converts a detected current to generate a current detection signal Vc and outputs the current detection signal Vc.

The first circuit 8 in the control circuit 5 outputs a first signal Vx, based on the error signal Ve and the current detection signal Vc which are to be input thereto. Specifically, the first circuit 8 outputs the first signal Vx of an H level when the level of the current detection signal Vc is equal to or lower than a level set by the error signal Ve. The first circuit 8 outputs the first signal Vx of an L level when the level of the error signal Ve indicates that the output voltage Vo exceeds a desired value.

In the second circuit 9 in the control circuit 5, the first comparator 91 compares the current detection signal Vc with a set value Vr1 and the second comparator 92 compares the current detection signal Vc with a second set value Vr2. In this case, it is assumed that the relationship between the first set value Vr1 and the second set value Vr2 satisfies the relationship expressed by Vr1>Vr2. An output of the first comparator 91 is received by a D terminal of the first D latch 94 and an output of the second comparator 92 is received by a D terminal of the second D latch 95. The second driving signal V2 output from the driving circuit 10 to the low side switch 2 is received by a CK terminal of each of the first D latch 94 and the second D latch 95 via a delay circuit 93. Accordingly, the first D latch 94 outputs, as a first output signal Vy1, respective outputs of the first comparator 91 and the delay circuit 93 after a lapse of a predetermined time from turning ON of the low side switch 2 set by the delay circuit 93. The second D latch 95 outputs, as a second output signal Vy2, respective outputs of the second comparator 92 and the delay circuit 93 after a lapse of a predetermined time from turning ON of the low side switch 2 set by the delay circuit 93.

In the second circuit 9, the timer circuit 96 receives the first driving signal V1 output from the driving circuit 10 to the high side switch 1, the first output signal Vy1 from the first D latch 94 and the second output signal Vy2 from the second D latch 95. The timer circuit 96 outputs the second signal Vy for determining an ON time of the high side switch 1, based on the first output signal Vy1 from the first D latch 94 and the second output signal Vy2 from the second D latch 95.

If the first signal Vx from the first circuit 8 is the H level, the driving circuit 10 in the control circuit 5 turns OFF the low side switch 2 by the first driving signal V1 and turns ON the high side switch 1 by the second driving signal V2. If the second signal Vy from the second circuit 9 is the H level, the driving circuit 10 turns OFF the high side switch 1 by the first driving signal V1 and turns ON the low side switch 2 by the second driving signal V2. Moreover, the driving circuit 10 receives the current detection signal Vc from the current detection circuit 7. Thus, when a current flowing in the low side switch 2 reaches 0, the driving circuit 10 turns OFF the low side switch 2 by the second driving signal V2.

Hereinafter, the operation of the DC-DC converter of the first embodiment of the present invention shown in FIG. 1 under heavy load conditions will be described.

When the high side switch 1 is ON, a voltage difference (Vi−Vo) between the input voltage Vi and the output voltage Vo is applied to the inductor 3. At this time, the current IL flowing in the inductor 3 is linearly increased, and magnetic energy is stored in the inductor 3.

On the other hand, when the high side switch 1 is OFF, the output voltage Vo is applied to the inductor 3 in the inverse direction. At this time, the inductor current IL flowing in the inductor 13 is linearly reduced, and the inductor 3 releases magnetic energy.

The inductor current IL flowing in the inductor 3 is smoothed by the output capacitor 4 and an averaged direct current is supplied to the output terminal. The output voltage Vo is fed back to an inversion input of the output detection circuit 6. The reference voltage Vr is received by a non-inversion input of the output detection circuit 6. The output direction circuit 6 outputs the error signal Ve obtained by amplifying a difference between the output voltage Vo and the reference voltage Vr to the first circuit 8. Moreover, the current detection signal Vc obtained by current-voltage inversion of a current flowing in the low side switch 2 by the current detection circuit 7 is received by the first circuit 8.

At this time, when the inductor current IL flowing in the inductor 3 is reduced and the current detection signal Vc from the current detection circuit 7 is reduced to the level of the error signal Ve from the output detection circuit 6, the first circuit 8 outputs the first signal Vx of the H level. The driving circuit 10 which has received the first signal Vx of the H level changes the second driving signal V2 to the L level to turn OFF the low side switch 2 and changes the first driving signal V1 to the H level to turn ON the high side switch 1. Thus, excitation of the inductor 3 is started, and the inductor current IL is linearly increased.

The timer circuit 96 for setting an ON time of the high side switch 1 is connected to the driving circuit 10. Thus, the second signal Vy from the timer circuit 96 becomes the H level after a lapse of a predetermined time from a time when the first driving signal V1 from the driving circuit 10 becomes the H level and the high side switch 1 is turned ON. The driving circuit 10 receives the second signal Vy of the H level, thereby making the first driving signal V1 be the L level to turn OFF the high side switch 1 and making the second driving signal V2 be the H level to turn ON the low side switch 2.

Since the DC-DC converter is under heavy load conditions, in the second circuit 9, the level of the current detection signal Vc after a lapse of a delay time from a time when the second driving signal V2 becomes the H level is higher than each of the first set value Vr1 and the second set value Vr2 and each of the first output signal Vy1 from the first D latch 94 and the second output signal Vy2 from the second D latch 95 is the L level. The timer circuit 96 changes the second output signal Vy to the H level after an ON time to be set when the first driving signal V1 becomes the H level and each of the first output signal Vy1 and the second output signal Vy2 is the L level. The detail configuration and operation of the timer circuit 96 will be described later.

The case where with the above-described configuration, for example, the output current Io from the output terminal is increased, so that the output voltage Vo becomes lower than a desired level will be considered. In such a case, the output detector circuit 6 which has detected a reduction in the output voltage Vo increases the error signal Ve which the output detection circuit 6 is to output. When the error signal Ve is increased, a time which it takes for the current detection signal Vc of the low side switch 2 to reach the level of the error signal Ve is reduced. In other words, a time during which the high side switch 1 is OFF is reduced. The ON time of the high side switch 1 set by the timer circuit 96 is constant and thus the inductor current IL is increased overall. Thus, a power supplied to the output capacitor 4 is increased and the output voltage Vo which has been reduced is increased.

In contrast, the case where the output current Io from the output terminal is reduced, so that the output voltage Vo rises above a desired level will be considered. In such a case, the output detection circuit 6 which has detected an increase in the output voltage Vo reduces the error signal Ve which the output detection circuit 6 is to output. When the error signal Ve is reduced, a time which it takes for the current detection signal Vc of the low side switch 2 to reach the level of the error signal Ve is increased. In other words, a time during which the high side switch 1 is OFF is increased. The ON time of the high side switch 1 set by the timer circuit 96 is constant and thus the inductor current IL is reduced overall. Thus, a power supplied to the output capacitor 4 is reduced and the output voltage Vo which has been increased is reduced.

Thus, under heavy load conditions where the output current Io is sufficiently large, the DC-DC converter of the first embodiment of the present invention is operated so as to maintain a predetermined output voltage Vo.

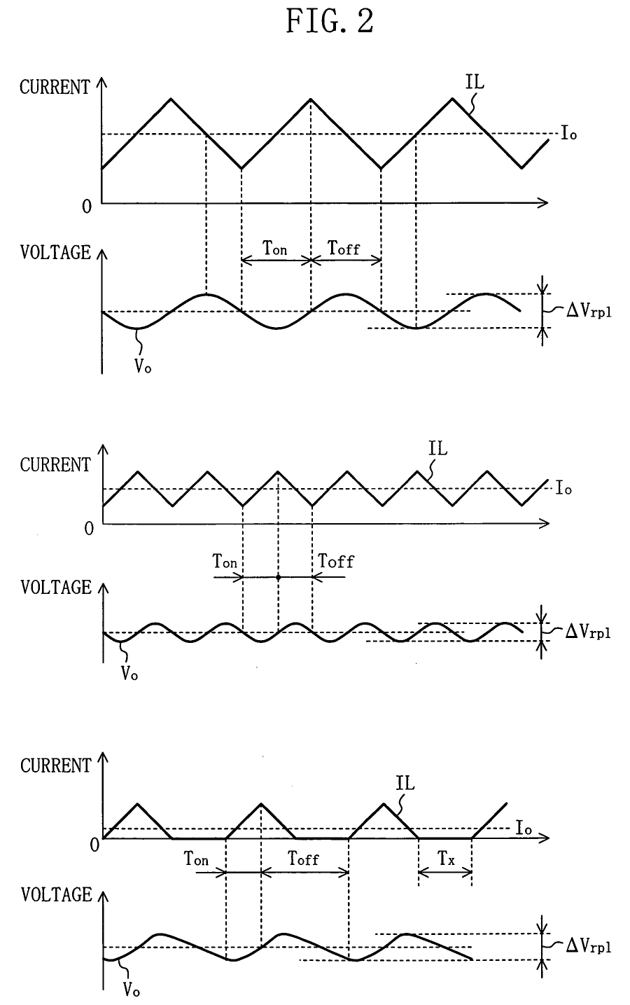

FIGS. 2A through 2C are operation waveform charts illustrating inductor current IL and output voltage Vo in the DC-DC converter of the first embodiment of the present invention. FIG. 2A shows a waveform when the inductor current IL flowing in the inductor 3 is large under heavy load conditions.

As shown in FIG. 2A, if the high side switch 1 and the low side switch 2 are repeatedly turned ON/OFF in an alternating manner, an operation waveform chart having a triangular wave shape in which the inductor current IL is linearly increased/reduced is obtained. An average value for the inductor current IL becomes an output current Io and a current (IL−Io) obtained by subtracting the output current Io from the inductor current IL becomes a ripple current flowing in the output capacitor 4. Fluctuation in voltage of the output capacitor 4 associated with the ripple current (IL−Io) is superimposed on the output voltage Vo as an output ripple voltage Vrpl. If the switching cycle is T, a variation range of the inductor current IL is ΔIL, and a capacitance of the output capacitor 4 is C, the amplitude ΔVrpl of the output ripple voltage can be expressed by Equation 4.
ΔVrpl=ΔIL×T/(4C) [Equation 4]

Next, the operation of the DC-DC converter of the first embodiment of the present invention shown in FIG. 1 under light load conditions, i.e., the operation thereof when the output current Io is reduced will be described.

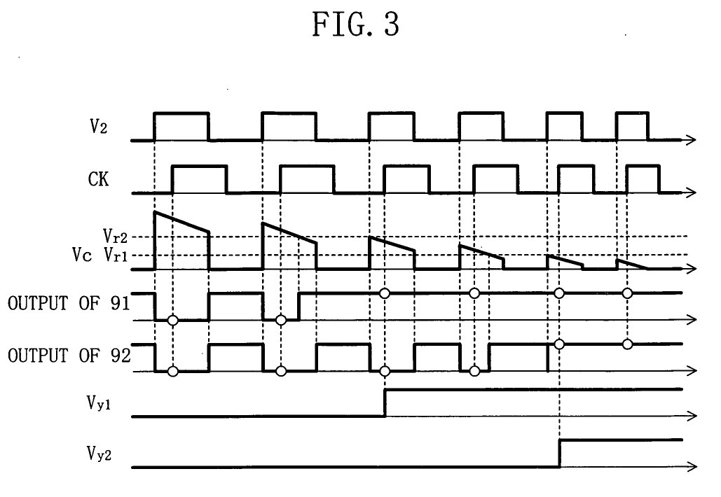

When the output current Io is reduced, the second driving signal V2 becomes the H level and the current detection signal Vc after a delay time is reduced. Accordingly, respective signal levels of the first output signal Vy1 from the first D latch 94 and the second output signal Vy2 from the second D latch 95 are inverted from the L level to the H level in this order as the level of the current detection signal Vc is reduced. The timer circuit 96 reduces the ON time of the high side switch 1 as the state of the signal levels of the first output signal Vy1 and the second output signal Vy2 input thereto is changed from (Vy1=L level and Vy2=L level) to (Vy1=H level and Vy2=L level) and then to (Vy1=H level and Vy2=H level). This is the operation indicated in the operation waveform chart for the second circuit 9 shown in FIG. 3. FIG. 3 illustrates operation waveform charts of the second driving signal V2, an output CK of the delay circuit 93, the current detection signal Vc, an output of the first comparator 91, an output of the second comparator 92, the first output signal Vy1 of the first D latch 94 and the output signal Vy2 from the second D latch 95.

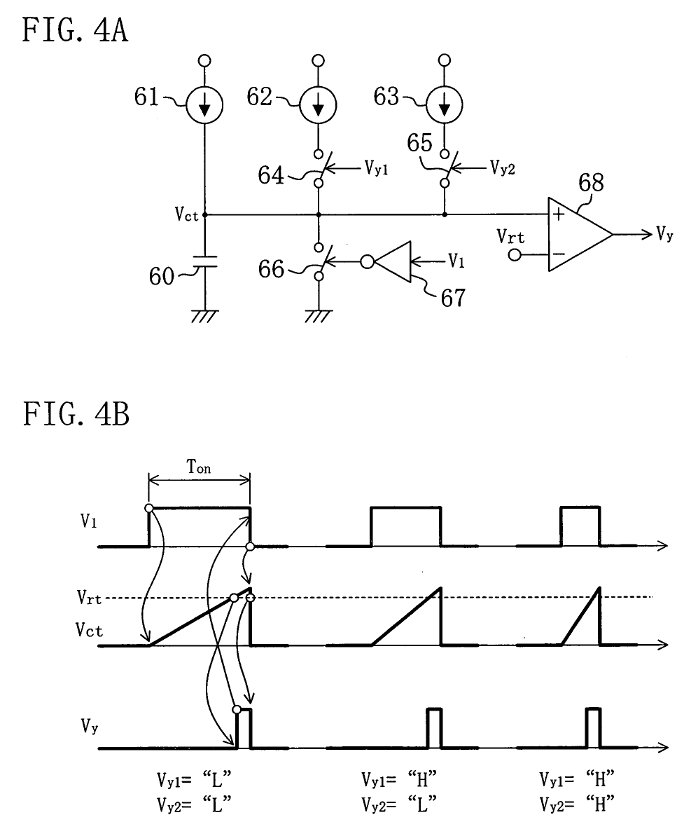

Next, a circuit configuration of the timer circuit 96 will be described with reference to FIG. 4.

As shown in FIG. 4, the timer circuit 96 includes a capacitor 60, a first constant current power supply 61, a second constant current power supply 62, a third constant current power supply 63, a first switch 64, a second switch 65, a third switch 66, an inverter 67 and a comparator 68.

The first, second and third constant current sources 61, 62 and 63 are connected so that each of the constant current sources 61, 62 and 63 charges the capacitor 60 at a predetermined constant current value. The first switch 64 is turned ON when the first output signal Vy1 from the first D latch 94 is the H level and connects the second constant current power supply 62 to the capacitor 60. The second switch 65 is turned ON when the second output signal Vy2 from the second D latch 95 is the H level, and connects the third constant current power supply 63 to the capacitor 60.

When the first driving signal V1 is the L level, i.e., the high side switch 1 is OFF, the third switch 66 is ON via the inverter 67 and the capacitor 60 discharges through the ground potential. The comparator 68 compares a voltage Vct of the capacitor 60 with a reference voltage Vrt and outputs, as the second signal Vy, a result of the comparison.

When the first driving signal V1 becomes the H level, the third switch 66 is turned OFF and the capacitor 60 is charged. In this case, when the first output signal Vy1 is the L level and the second output signal Vy2 is the L level (Vy1=L and Vy2=L), the capacitor 60 is charged only by the first constant current power supply 61. When the first output signal Vy1 is the H level and the second output signal Vy2 is the L level (Vy1=H and Vy2=L), the capacitor 60 is charged by the first constant current power supply 61 and the second constant current power supply 62. When the first output signal Vy1 is the H level and the second output signal Vy2 is the H level (Vy1=H and Vy2=H), the capacitor 60 is charged by the first constant current power supply 61, the second constant current power supply 62 and the third constant current power supply 63.

The capacitor 60 is charged so that the voltage Vct of the capacitor 60 is increased to exceed the reference voltage Vrt, the second signal Vy output from the comparator 68 is inverted from the L level to the H level. In response to the H level of the second signal Vy, the deriving circuit 10 changes the first driving signal V1 to the L level to turn OFF the high side switch 1. At this time, the first driving signal V1 becomes the L level, so that the capacitor 60 is discharged and the second signal Vy returns to the L level. As has been described, a charging time for the capacitor 60 corresponds to the ON time of the high side switch 1 and a charging current for the capacitor 60 is increased as respective logic values of the first output signal Vy1 and the second output signal Vy2 change to (L, L), (H, L) and then (H, H). Accordingly, the charging time for the capacitor 60 is reduced. That is, the ON time of the high side switch 1 is reduced in a stepwise manner as the load becomes lighter.

FIG. 2B is an operation waveform chart for the inductor current IL and the output voltage Vo under light load conditions in the DC-DC converter of the first embodiment of the present invention. As shown in FIG. 2B, respective operations of the inductor current IL and the output voltage Vo are the same as those under heavy load conditions shown in FIG. 2A. Thus, in the same manner, an amplitude ΔVrpl of an output ripple voltage can be expressed by Equation 5.
ΔVrpl=ΔIL×T/(4C) [Equation 5]

However, the ON time of the high side switch 1 is reduced, and the switching cycle T and the variation range ΔIL of the inductor current IL are reduced. If the ON time of the high side switch 1 is ½ of that under heavy load conditions, each of the switching cycle T and the variation range ΔIL of the inductor current IL becomes ½ of that under heavy load conditions. Accordingly, on calculation, the amplitude ΔVrpl of an output ripple voltage is reduced to ¼ of that under heavy load conditions.

Moreover, an output current Iox in the case of a discontinuous operation in which a valley value of the inductor current IL is 0 is expressed by Equation 6.
Iox=ΔIL/2 [Equation 6]
Thus, when the ON time of the high side switch 1 is reduced under light load conditions, the output current Iox at the time when a continuous operation is changed to a discontinuous operation is reduced. That is, a continuous operation region becomes wider.

Furthermore, when a light load is provided and an output current is reduced, a valley value of the inductor current IL becomes 0. When the driving circuit 10 detects that a detection current having reached 0 by the current detection signal Vc, the driving circuit 10 changes the second driving signal V2 to the L level to turn OFF the low side switch 2. In such a discontinuous operation, the error signal Ve becomes a level at which a valley of the inductor current IL is 0 or lower than 0, and the first signal Vx stays at the L level and the high side switch 1 is not turned ON. A current flowing via the inductor 3 is not supplied to the output capacitor 4 and this causes reduction in the output voltage Vo for discharge by the output current Io. When the output voltage Vo becomes below a desired level, the error signal Ve is increased and the first circuit 8 changes the first signal Vx to the H level to turn ON the high side switch 1. The inductor current IL flows during the ON time of the high side switch 1 set by the timer circuit 96 and the ON time of the low side switch 2 which follows the ON time of the high side switch 1, and the output voltage Vo is increased. When the output voltage Vo exceeds a desired level, the error signal Ve is reduced. The above-described operation is repeated.

FIG. 2C is an operation waveform chart for the inductor current IL and the output voltage Vo under light load conditions in the DC-DC converter of the first embodiment of the present invention when a discontinuous operation is started.

As shown in FIG. 2C, the ON time Ton of the high side switch 1 under light load conditions is shorter than the ON time Ton under heavy load conditions. Accordingly, the variation range ΔIL of the inductor current IL is small. However, because the period Tx in which the inductor current IL is 0 exists, a charging amount in a single switching cycle is larger than that in the case of FIG. 2B and an output voltage is increased. The amplitude ΔVrpl of the output ripple voltage is expressed by Equation 7.
ΔVrpl=(ΔIL−Io)²×(T−Tx)/(2C×ΔIL) [Equation 7]

If (T−Tx) is equal to the switching cycle T shown in FIG. 2B and {(T−Tx)=T} holds and the output current Io is 0 and (Io=0) holds, the amplitude ΔVrpl of the output ripple voltage is expressed by Equation 8.
ΔVrpl=ΔIL×T/(2C) [Equation 8]
If each of the switching cycle T and the variation range ΔIL of the inductor current IL is ½ of that under heavy load conditions, the amplitude ΔVrpl of the output ripple voltage is reduced to be ½ of that under heavy load conditions.

As has been described, by changing the ON time of the high side switch 1 under light load conditions, for example, to 1/k of the ON time of the high side switch 1 under heavy load conditions, the amplitude ΔVrpl of the output ripple voltage when a discontinuous operation in which a valley value of the inductor current IL is 0 is started is reduced to be (1/k)² on calculation, and a maximum value of the amplitude ΔVrpl of the output ripple voltage when a discontinuous operation is started when the load is lighter can be made to be 1/k. Thus, in the DC-DC converter of the first embodiment of the present invention, the output voltage Vo under light load conditions can be controlled with high accuracy.

In the DC-DC converter of this embodiment, for a set value with which the current detection signal Vc is compared, two values, i.e., the first set value Vr1 and the second set value Vr2 are used. For a comparator, two comparators, i.e., the first comparator 91 and the second comparator 92 are provided. For a D latch, two D latches, i.e., the first D latch 94 and the second D latch 95 are provided. Thus, the DC-DC converter has a configuration in which the ON time of the high side switch 1 can be set to three different lengths. However, the present invention is not limited to the above-described configuration. By adopting a configuration in which n groups of a set value to which the current detection signal Vc, a comparator and a D latch are provided, the ON time of the high side switch 1 can be set in (n+1) stages.

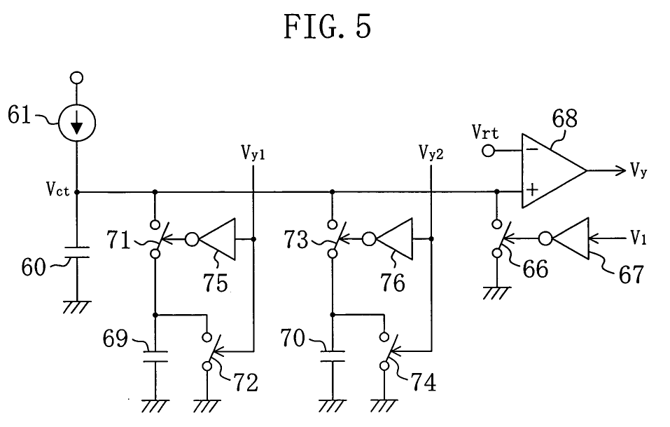

The timer circuit 96 in the DC-DC converter of this embodiment has a configuration in which the capacitor 60 is charged by switching from one to another between a plurality of constant current sources, thereby making the ON time of the high side switch 1. However, the present invention is not limited to the above-described configuration. For example, as shown in FIG. 5, a DC-DC converter according to this embodiment may have a configuration in which only a single constant current power supply is provided and charging is performed by switching from one to another between a plurality capacitors having different capacitances, respectively, thereby making the ON time of the high side switch 1 variable. FIG. 5 is a circuit diagram illustrating a modified example of the circuit configuration of the timer circuit 96 when a single constant current power supply is provided.

As shown in FIG. 5, the timer circuit 96 includes, instead of the second constant current power supply 62, the third constant current power supply 63, the first switch 64 and the second switch 65 which are shown in FIG. 4, a second capacitor 69, a third capacitor 70, a fourth switch 71, a fifth switch 72, a sixth switch 73, a seventh switch 74, a second inverter 75, and a third inverter 76. The fourth switch 71 for receiving a first output signal Vy1 via the second inverter 75 receives the first output signal Vy1 of the L level and is turned ON, thereby connecting the second capacitor 69 to the capacitor 60 in parallel. The fifth switch 72 receives the output signal Vy1 of the H level and is turned ON, thereby causing short-circuit discharge of the second capacitor 69. The sixth switch 73 for receiving the second output signal Vy2 via the inverter 76 receives the second output signal Vy2 of the L level and is turned ON, thereby connecting the third capacitor 70 to the capacitor 60 in parallel. The fourth switch 74 receives the output signal Vy2 of the H level and is turned ON, thereby causing the third capacitor 70 start short-circuit discharge.

When the first driving signal V1 is the L level, i.e., the high side switch 1 is OFF, the third switch 66 is turned ON via the inverter 67 and the capacitor 60 discharges through a ground potential. The comparator 68 compares a capacitor voltage Vct with a reference voltage Vrt and outputs a second signal Vy. When the first driving signal V1 becomes the H level, the third switch 66 is turned OFF. In this case, when the first output signal Vy1 is the L level and the second output signal Vy2 is the L level (Vy1=L and Vy2=L), the capacitor 60, the second capacitor 69 and the third capacitor 70 are charged. When the first output signal Vy1 is the H level and the second output signal Vy2 is the L level (Vy1=H, Vy2=L), the capacitor 60 and the second capacitor 69 are charged. When the first output signal Vy1 is the H level and the second output signal Vy2 is the H level (Vy1=H and Vy2=H), only the capacitor 60 is charged. If the capacitor voltage Vct is increased by being charged to exceed the reference voltage Vrt, the second signal Vy from the comparator 68 is inverted from the L level to the H level. When the driving circuit 10 receives the second signal Vy of the H level, the driving circuit 10 changes the first driving signal V1 to the L level to turn OFF the high side switch 1. Accordingly, the capacitor 60 is discharged and the second signal Vy returns to the L level. As have been described, a charging time for the capacitor 60 corresponds to the ON time of the high side switch 1 and respective logic values of the first output signal Vy1 and the second output signal Vy2 are changed to (L, L), (H, L) and then (H, H). Accordingly, a capacitor to be charged is reduced, and charging time for the capacitor 60 is reduced. That is, as the load becomes lighter, the ON time of the high side switch 1 is reduced in a stepwise manner.

The DC-DC converter of this embodiment has a configuration in which based on the level of the current detection signal Vc after a lapse of a predetermined time from turning ON of the low side switch 2, whether or not a load is light is judged. For example, the DC-DC converter may have a structure in which a current detection circuit for detecting an output current is separately provided to perform a judgment.

Moreover, for the operation of the DC-DC converter of this embodiment, as a method for setting an OFF period of a switch so that the inductor current IL becomes 0 in a discontinuous operation, a method in which the level of the error signal Ve is used has been described. However, the present invention is not limited to the method using the error signal Ve. Even if a method in which a signal obtained by comparison between a desired level of the output voltage or another reference value determined based on a desired level is used, an OFF time of a switch can be set.

### Second Embodiment

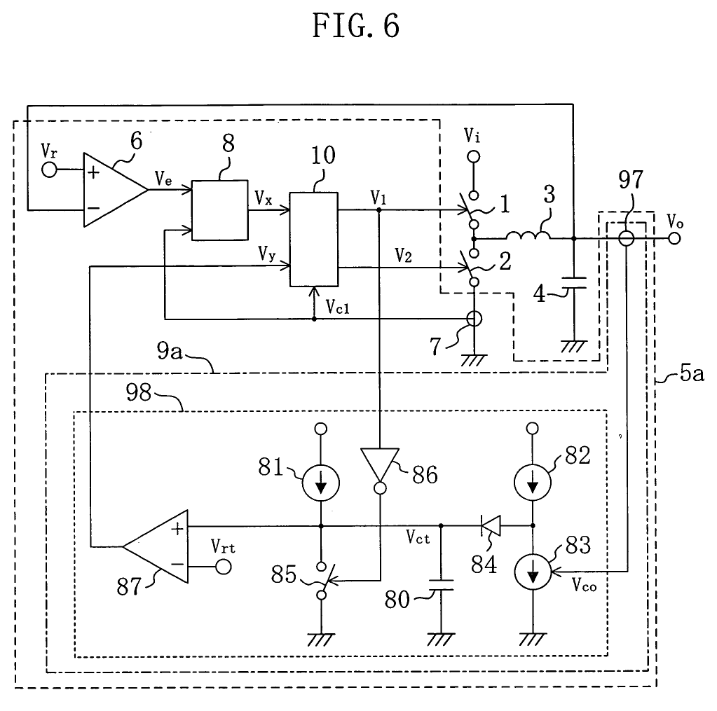

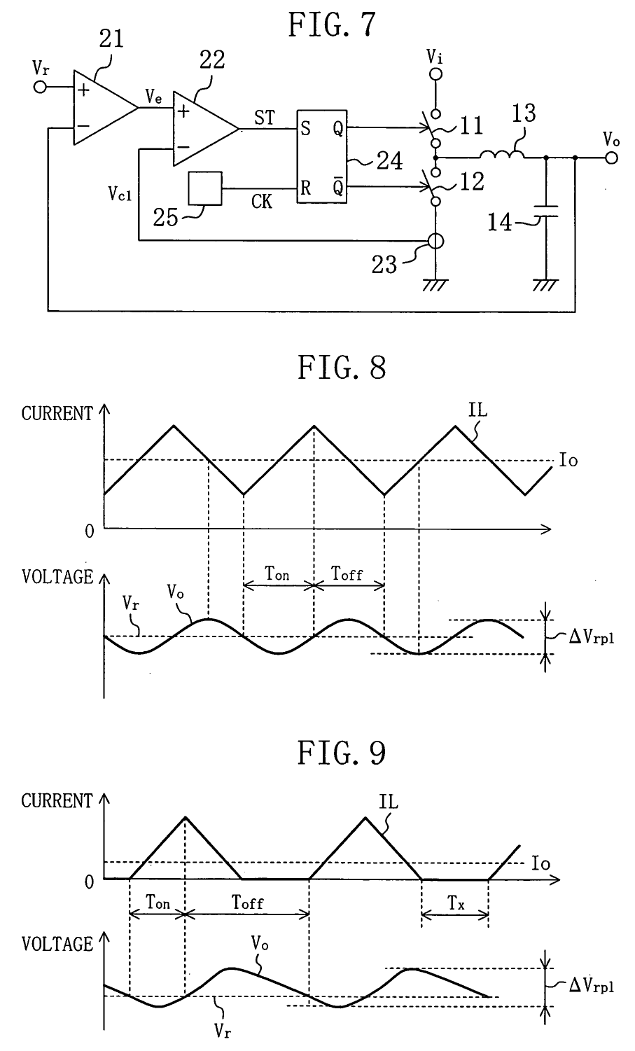

Hereinafter, a DC-DC converter according to a second embodiment of the present invention will be described with reference to FIG. 6.

First, a circuit configuration of a DC-DC converter according to the second embodiment of the present invention will be described.

FIG. 6 is a circuit diagram illustrating an exemplary circuit configuration of the DC-DC converter of the second embodiment of the present invention. In the DC-DC converter of the second embodiment shown in FIG. 6, each member also shown in FIG. 1 of the first embodiment is identified by the same reference numeral and therefore the description thereof will be omitted.

The DC-DC converter of the second embodiment shown in FIG. 6 is different from the DC-DC converter of the first embodiment shown in FIG. 1 in a configuration of a control circuit. Specifically, the control circuit 5a in the DC-DC converter of the second embodiment includes an output detection circuit 6, a current detection circuit 7, a first circuit 8, a second circuit 9a, and a driving circuit 10 as in the first embodiment, but a circuit configuration of the second circuit 9a forming the control circuit 5a is different from the circuit configuration of the second circuit 9 for forming the control circuit 5 in the first embodiment.

The second circuit 9a includes a current detection circuit 97 for detecting an output current Io and outputting an output current detection signal Vco and a timer circuit 98 for receiving the output current detection signal Vco from the current detection circuit 97. Moreover, the timer circuit 98 includes a capacitor 80, a first constant current power supply 81, a second constant current power supply 82, a voltage-current converter circuit 83, a diode 84, a switch 85, an inverter 86 and a comparator 87.

Hereinafter, the operation of the timer circuit 98 for reducing an ON time of a high side switch 1 under light load conditions will be described.

In the timer circuit 98, the first constant current power supply 81 is connected to the capacitor 80 so as to charge the capacitor 80. The second constant current power supply 82 and the voltage-current converter circuit 83 are connected in series. An anode of the diode 84 is connected to a junction of the second constant current power supply 82 and the voltage-current converter circuit 83. A cathode of the diode 84 is connected to the capacitor 80. The voltage-current converter circuit 83 voltage-current converts the output current detection signal Vco and flows a current corresponding to the output current Io. When the current of the voltage-current converter circuit 83 is equal to or more than a current of the second constant current power supply 82, the diode 84 becomes nonconductive. On the other hand, when the current of the voltage-current converter circuit 83 is less than the current of the second constant current power supply 82, the capacitor 80 is charged by a differential current of the current of the voltage-current converter circuit 83 flowing via the diode 84 and the current of the second constant current 82.

When the first driving signal V1 is the L level, i.e., the high side switch 1 is OFF, the switch 85 is turned ON via the inverter 86. Accordingly, the capacitor 80 discharges through a ground potential. The comparator 87 compares the voltage Vct of the capacitor 80 with the reference voltage Vrt and outputs a result of the comparison as the second signal Vy. When the first driving signal becomes the H level, the switch 85 is turned OFF and the capacitor 80 is charged. If the voltage Vct of the capacitor 80 is increased by being charged to exceed the reference voltage Vrt, the second signal Vy from the comparator 87 is inverted from the L level to the H level. The driving circuit 10 receives the second signal Vy of the H level and then changes the first driving signal V1 to the L level to turn OFF the high side switch 1. Accordingly, the capacitor 80 is discharged and the second signal Vy returns to the L level.

When the output current Io is large and the current of the voltage-current converter circuit 83 is equal to or more than the current of the second constant current power supply 82, the diode 84 becomes nonconductive. Accordingly, in this case, the capacitor 80 is charged only by the first constant current power supply 81. However, when the output current Io is small and the current of the voltage-current converter circuit 83 is less than the current of the second constant current power supply 82, the capacitor 80 is charged by a differential current of the current of the voltage-current converter circuit 83 flowing via the diode and the current of the second constant current power supply 82. Accordingly, in this case, a charging current for the capacitor 80 is increased and a charging time for the capacitor 80 is reduced. That is, as the load is lighter and the output current Io is smaller, the ON time of the high side switch 1 becomes smaller.

As described above, with the DC-DC converter of the second embodiment of the present invention, the following effects can be achieved. In the DC-DC converter of the first embodiment, as the output current Io becomes smaller, the ON time of the high side switch 1 is reduced in a stepwise manner. In the DC-DC converter of the second embodiment, when the output current Io becomes smaller than a predetermined value, the ON time of the high side switch 1 is continuously reduced according to a current difference therebetween. In the DC-DC converter of the first embodiment in which the ON time is reduced in a stepwise manner, if the ON time is reduced under a discontinuous operation, a power supplied to the output capacitor 4 is rapidly reduced, so that an unstable operation might be caused. However, in the DC-DC converter of the second embodiment in which the ON time is continuously reduced, advantageously, there is no need to take it into consideration which the inductor current IL is in a continuous operation or a discontinuous operation.

In this embodiment, to simplify the description of operations, a circuit configuration in which the ON time is continuously reduced by detecting an output current is used. However, as in the first embodiment, by detecting a current of the low side switch 2, the same effects can be achieved. For example, with a configuration in which the level of the current detection signal Vc after a lapse of a predetermined time from turning ON of the low side switch 2 is sampled and held, a signal corresponding to the output current detection signal Vco in this embodiment can be achieved.

As a DC-DC converter according to the first or second embodiment, a step-down switching converter is used as an example. However, the present invention is not limited to a step-down switching converter. Nonetheless to say, the present invention is applicable to a switching converter of any kinds which has a switch and an inductor and in which an inductor current is periodically increased/reduced by a switching operation and a valley value of the inductor current is controlled, thereby controlling a DC power supplied to a load.

The present invention is useful to a DC-DC converter which includes a switch and an inductor and in which an inductor current is periodically increased/reduced by a switching operation and a valley value of the inductor current is controlled, thereby controlling a DC power supplied to a load.

What is claimed is:

1. A DC-DC converter comprising:
a switch for receiving an input voltage and applying the input voltage or part of the input voltage to an inductor by an ON/OFF operation;
a rectifier for rectifying a voltage generated in the inductor;
a smoothing circuit for smoothing the rectified voltage to generate an output voltage; and
a control circuit for generating a control signal for controlling the ON/OFF operation and outputting the control signal to the switch,
wherein the control circuit includes
an output detection circuit for outputting an error signal corresponding to a difference between the output voltage and a reference voltage,
a current detection circuit for detecting a current flowing in the inductor in a period in which at least the switch is OFF and outputting a result of the detection as a current direction signal,
a first circuit for generating a first signal for setting a timing of turning ON of the switch according to a result of comparison between the error signal and the current detection signal and outputting the first signal, and
a second circuit for generating a second signal for setting an ON time of the switch, according to reduction in output power from the smoothing circuit, so that the ON time of the switch is reduced, and
wherein the control circuit generates the control signal, based on the first signal and the second signal.

2. The DC-DC converter of claim 1, wherein the second circuit generates the second signal according to a level of the current detection signal.

3. The DC-DC converter of claim 1, wherein the second circuit generates the second signal, according to a level of the current detection signal, so that the ON time of the switch is reduced in a stepwise manner.

4. The DC-DC converter of claim 3, wherein the second circuit includes a comparator for comparing the current detection signal with a predetermined value, a latch circuit for maintaining an output of the comparator after a lapse of a predetermined time from turning OFF of the switch and outputting the output, and a timer circuit for receiving an output of the latch circuit and generating the second signal.

5. The DC-DC converter of claim 4, wherein the timer circuit includes a plurality of constant current sources, a capacitor and a comparator, and
wherein in receiving the output of the latch circuit, the timer circuit switches the plurality of constant current sources from one to another to charge the capacitor and sets the ON time of the switch according to a charging time for the capacitor.

6. The DC-DC converter of claim 4, wherein the timer circuit includes a constant current source, a plurality of capacitors and a comparator, and
wherein in receiving the output of the latch circuit, the timer circuit switches the plurality of capacitors from one to another to charge the plurality of capacitors and sets the ON time of the switch according to a charging time for the plurality of capacitors.

7. The DC-DC converter of claim 4, wherein the second circuit includes a plurality of pairs of the comparator and the latch circuit, and
wherein in receiving a plurality of outputs of the plurality of latch circuits, the timer circuit generates the second signal according to a combination of the plurality of outputs.

8. The DC-DC converter of claim 7, wherein the timer circuit includes a plurality of constant current sources, a capacitor and a comparator, and
wherein in receiving the outputs of the latch circuits, the timer circuit switches the plurality of constant current sources from one to another to charge the capacitor and sets the ON time of the switch according to a charging time for the capacitor.

9. The DC-DC converter of claim 7, wherein the timer circuit includes a constant current source, a plurality of capacitors and a comparator, and
wherein in receiving the outputs of the latch circuits, the timer circuit switches the plurality of capacitors from one to another to charge the plurality of capacitors and sets the ON time of the switch according to a charging time for the plurality of capacitors.

10. The DC-DC converter of claim 1, wherein the second circuit generates the second signal according to a level of a signal which has detected the output current from the smoothing circuit.

11. The DC-DC converter of claim 10, wherein when the level of the signal which has detected the output current from the smoothing signal is smaller than a predetermined value, the second circuit generates the second signal so that the larger a difference between the level of the signal and the predetermined value is, the smaller the ON time of the switch becomes.

12. The DC-DC converter of claim 10, wherein the second circuit includes an output current detection circuit for detecting the output current from the smoothing circuit and generating an output current detection signal, and a timer circuit for generating the second signal according to the level of the output current detection signal.
